(19) United States
(12) Patent Application Publication
(10) Pub. No.: US 2026/0049694 A1
(43) Pub. Date: Feb. 19, 2026

(54) HYDROGEN (H2) FUEL TANK SYSTEM CONTROL FOR IMPROVED H2 VEHICLE EFFICIENCY AND RANGE

(71) Applicant: Volvo Truck Corporation, Göteborg (SE)

(72) Inventors: Johan CARLÉN ANDERSSON, Lund (SE); Fredrik RAHM, Hörby (SE); Erik Johannes SVENSSON, Malmö (SE)

(21) Appl. No.: 19/102,506

(22) PCT Filed: Aug. 16, 2022
(86) PCT No.: PCT/IB2022/057664

§ 371 Date: Feb. 10, 2025

(51) Int. Cl. F17C 7/00; F02M 21/02

(52) U.S. Cl. CPC F17C 7/00; F02M 21/0206; F02M 21/0221; F17C 2221/012; F17C 2227/0135; F17C 2250/032; F17C 2250/043; F17C 2250/0636; F17C 2265/066; F17C 2270/0171

(57) ABSTRACT

A method to increase efficiency in a hydrogen fuel system requiring high pressure hydrogen injection and having a plurality of hydrogen fuel tanks, the method including controlling one or more hydrogen fuel tanks and at least one hydrogen fuel tank to provide fuel in parallel to the hydrogen fuel consumer. The method includes determining when an intermediate tank pressure threshold has been reached in all hydrogen fuel tanks. The method includes responsive to the intermediate tank pressure threshold being reached in all of the hydrogen fuel tanks, removing the at least one hydrogen fuel tank from providing fuel to the hydrogen fuel consumer while using one or more hydrogen fuel tanks to provide hydrogen fuel to the fuel consumer. The method includes when an engine brake event has been detected, pumping hydrogen from the one or more hydrogen fuel tanks into the at least one hydrogen fuel tank.

### TECHNICAL FIELD

The disclosure relates generally to fuel tank systems. In particular aspects, the disclosure relates to a fuel tank system having a plurality of hydrogen storage tanks used for direct injection of hydrogen into the cylinder of a hydrogen engine.

The disclosure can be applied in heavy-duty vehicles, such as trucks, buses, and construction equipment. Although the invention will be described with respect to a particular vehicle, the invention is not restricted to any particular vehicle.

### BACKGROUND

Internal combustion engines (ICEs) in general, and hydrogen (H2) engines in particular, need a precise control of both air/fuel ratio and EGR (Exhaust Gas Recirculation). Moreover, the spark ignited H2 ICE is very sensitive regarding autoignition (i.e., knock) which in turn depends on temperature, pressure and in cylinder gas composition.

Controlling the conditions in the cylinder is key for full control and optimization of a hydrogen engine.

One impacting factor is the actual available H2 pressure in the tanks when using direct injection. Direct injection is preferred over port injection since port injection has the risk of backfire with H2 in the intake system.

Using direct injection means that the pressure of H2 being injected into the cylinder must be higher than in the cylinder. Additionally, the higher the pressure difference, the faster the injection rate thus shorter injection time.

A critical factor is the time to inject the fuel. The longer it takes to inject, the earlier the injection must start to inject prior to ignition. Injecting fuel in an earlier phase (using lower pressure) has the risk of auto or pre-ignition. Thus, especially for a compression ignition dual fuel solution, high pressures with short injection time is necessary.

For a H2 tank system, this can be very limiting since there also is a level (tank pressure) when it is not possible to operate, or the engine power must be reduced.

In order to be able to keep running the engine (Spark Ignited but Compression Ignited in particular) at the same conditions, a H2 fuel pump is used to keep the pressure to the engine at the needed level.

The solution used today to address these challenges is either to use longer injection time (i.e., an earlier start of injection) when the pressure is reduced or to use a hydrogen booster pump to increase the pressure before the injection.

There currently exist certain challenge(s). This H2 pump requires more energy the lower the pressure is in the tanks-starting at 700 bar, below ˜150-200 bar the engine is not possible to run for a compression ignited dual fuel engine.

The energy requirement for this fuel compression is high and affects the fuel efficiency negatively for the complete system. Overall, a H2 engine is already suffering from needing many and large tanks to have a decent driving range. A reduced fuel efficiency, or not fully used tank content (H2) further decreases the range of, for example, a H2 combustion engine truck.

The drawback with this system is that there is a trade-off between optimum combustion characteristics and the power consumption to drive the pump. Since compressing to high pressures consume a lot of energy, the trade-off solution is far from engine or combustion efficiency optimized.

In addition, using a longer injection time requires a rematched hardware such as lowered compression ratio to avoid too early autoignition of the air fuel mixture, thus a less optimal system with lower power potential.

### SUMMARY

Certain aspects of the disclosure and their embodiments may provide solutions to these or other challenges.

According to some embodiments, a method to increase efficiency in a hydrogen fuel system requiring high pressure hydrogen injection and configured to provide brake energy recovery wherein the hydrogen fuel system has a plurality of hydrogen fuel tanks. The method includes controlling one or more hydrogen fuel tanks of the plurality of hydrogen fuel tanks and at least one hydrogen fuel tank to provide fuel in parallel to the hydrogen fuel consumer. The method includes determining when an intermediate tank pressure threshold has been reached in all of the one or more hydrogen fuel tanks and the at least one hydrogen fuel tank. The method includes responsive to the intermediate tank pressure threshold being reached in all of the one or more hydrogen fuel tanks and the at least one hydrogen fuel tank, removing the at least one hydrogen fuel tank from providing fuel to the hydrogen fuel consumer while using the one or more hydrogen fuel tanks to provide hydrogen fuel to the hydrogen fuel consumer. The method includes when an engine brake event has been detected, activating a pump to pump hydrogen from the one or more hydrogen fuel tanks into the at least one hydrogen fuel tank during the engine brake event.

Certain embodiments may provide one or more of the following technical advantage(s). The hydrogen fuel tanks are controlled in a selective manner to feed the H2 engine. Since it has several H2 tanks, some tanks are still full, while one or several are half full or empty.

Another advantage that can be achieved is that the H2 pump is not used to feed H2 directly to the fuel system/engine. The H2 pump is controlled/used only during braking or events when the vehicle (e.g., truck) has a regenerative power.

The emptying, pumping/filling of the hydrogen fuel tanks is done selectively based on the different fuel levels (pressures) in the hydrogen fuel tanks. The hydrogen fuel tank that currently is feeding the engine is not being pumped, but other tanks are being pressure boosted/refueled during brake events.

Since braking is a dissipation of energy, the cost of pressurizing the fuel in the H2 combustion engine truck can be minimized.

According to some other embodiments, a hydrogen fuel system requiring high pressure hydrogen injection and configured to provide brake energy recovery, where the hydrogen fuel system has a plurality of hydrogen fuel tanks is provided. The hydrogen fuel system includes a controller and a plurality of hydrogen fuel tanks, each of the plurality of hydrogen fuel tanks controlled by a fuel tank valve, each fuel tank valve controlled by the controller.

The hydrogen fuel system includes a hydrogen pump controlled by the controller and configured to pump fuel to at least one hydrogen fuel tank of the plurality of hydrogen fuel tanks from other hydrogen fuel tanks of the plurality of fuel tanks and a pump valve between the hydrogen pump and the other hydrogen fuel tanks.

The hydrogen fuel system includes a first valve between the fuel tank valves of the other hydrogen fuel tanks and a hydrogen fuel consumer. The hydrogen fuel system includes a second valve between the fuel tank valve of the at least one hydrogen fuel tank and the hydrogen fuel consumer, wherein the controller is configured to: control the first valve, the second valve, and the fuel tank valves of one or more hydrogen fuel tanks of the other hydrogen fuel tanks and the at least one hydrogen fuel tank to provide fuel in parallel to the hydrogen fuel consumer by opening the first valve, the second valve, the fuel tank valve of the at least one hydrogen fuel tank, and one or more fuel tank valves of the fuel tank valves of the other hydrogen fuel tanks; determine when an intermediate tank pressure threshold has been reached in the one or more hydrogen fuel tanks of the other hydrogen fuel tanks and the at least one hydrogen fuel tank; responsive to the intermediate tank pressure threshold being reached in all of the one or more hydrogen fuel tanks of the other hydrogen fuel tanks and the at least one hydrogen fuel tank, removing the at least one hydrogen fuel tank from providing fuel to the hydrogen fuel consumer by closing the second valve while using the one or more hydrogen fuel tank of the other hydrogen fuel tanks to provide hydrogen fuel to the hydrogen fuel consumer; when an engine brake event has been detected, open the pump valve, close the first valve, and activate the pump to pump hydrogen from the one or more hydrogen fuel tanks of the other hydrogen fuel tanks into the at least one hydrogen fuel tank during the engine brake event.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of a truck wherein the embodiments of the disclosure may be implemented;

FIG. 2 is a schematic illustration of a hydrogen fuel system according to some embodiments;

FIG. 3 is a schematic illustration of a controller of the hydrogen fuel system according to some embodiments;

FIGS. 4-10B are flow chart illustrating operations of the controller according to some embodiments of inventive concepts; and

FIG. 11 is a schematic illustration of a hydrogen fuel system according to further aspects.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Since also the pressure is key for both efficiency and power (especially for the compression ignition dual fuel solution where both fuels are direct injected in the cylinder at a later part of the compression stroke) when reducing the injection time, it is vital to keep the pressure up but also keep the pump energy usage low by using “waste” energy. For a spark ignited solution, one key is in avoiding knock that also relates to efficiency and power optimization. To optimize this system, it is important to have sufficient generator power for the pump drive during brake events.

Another principal factor is predictive control, knowing if and when waste energy (braking) will be available and plan (look ahead) to do this.

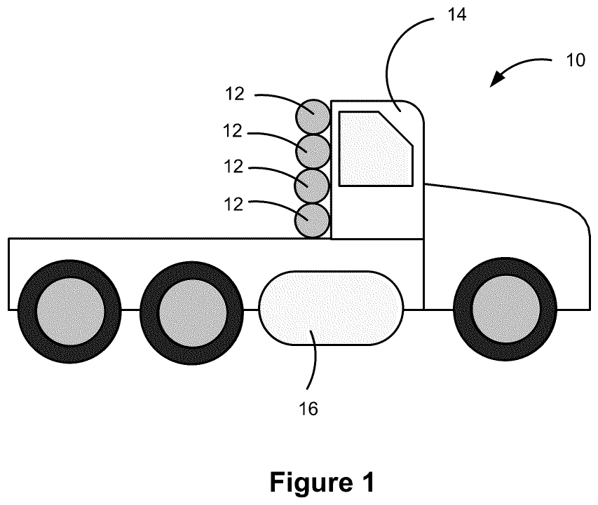

FIG. 1 provides an illustration of an environment where the hydrogen fuel system may be utilized. FIG. 1 illustrates a truck 10 having a hydrogen engine requiring direct fuel injection. The truck 10 has six hydrogen fuel tanks-four tanks 12 behind the cab 14 and two tanks 16 on each side (FIG. 1 shows one of the two tanks).

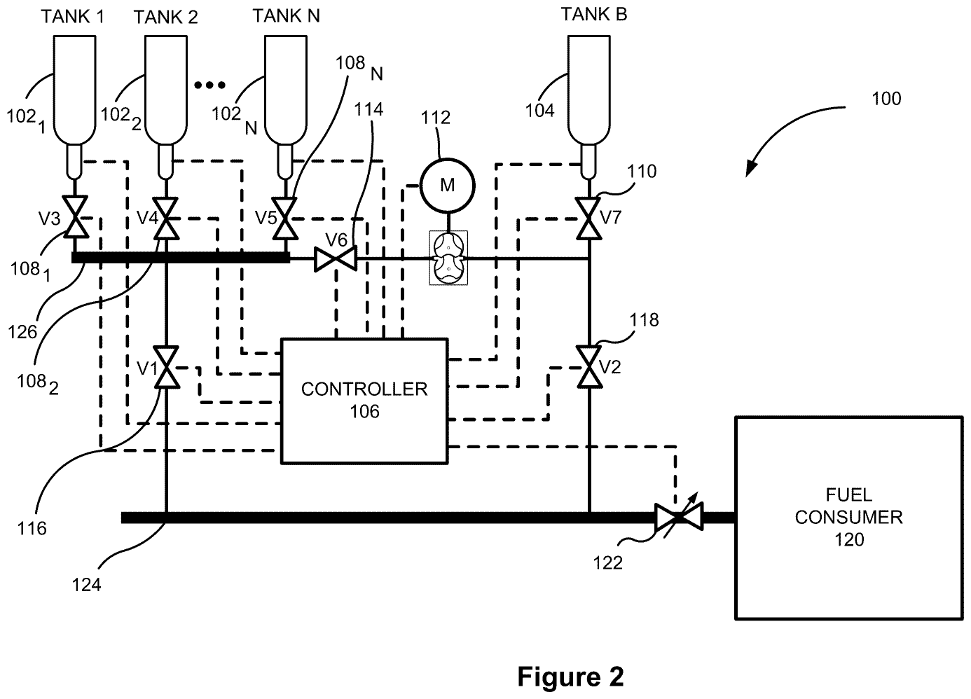

FIG. 2 illustrates an embodiment of a hydrogen fuel system according to some embodiments of the disclosure. Turning to FIG. 2, the hydrogen fuel system 100 has a plurality of hydrogen fuel tanks 1021-102N and at least one hydrogen fuel tank 104. While FIG. 2, shows just one hydrogen fuel tank 104, in other embodiments, there may be one or more hydrogen fuel tanks 104.

A controller 106 controls the plurality of hydrogen fuel tanks 1021-102N, the at least one hydrogen fuel tank 104, fuel tank valves 1081-108N associated with the plurality of hydrogen fuel tanks 1021-102N and fuel tank valve 110 associated with the at least one hydrogen fuel tank 104. While the fuel tank valves 1081-108N and the fuel tank valve 110 are shown as being separate from the hydrogen fuel tanks 1021-102N and the at least one hydrogen fuel tank 104, respectively, in some embodiments the fuel tank valves 1081-108N may be integrated with the hydrogen fuel tanks 1021-102N and/or the fuel tank valve 110 may be integrated with the at least one hydrogen fuel tank 104.

The sizing of the at least one hydrogen fuel tank 104 is based on determining the remaining amount of H2 in the system that cannot be utilized without pressurizing with energy during consumption. Therefore, it is important to have a limited tank size for the at least one hydrogen fuel tank 104. The at least one hydrogen fuel tank 104 may also be referred to as a booster tank. The tank size can be adjusted depending on the driving cycle, vehicle setup and vehicle load. For some cycles it may be more beneficial to have a larger booster tank volume, thus two tanks could be used for this or even more (depending on single tank size and number of tanks on the vehicle).

The pump 114 can be electrically or mechanically or hydraulically driven with a clutch or activation system controllable by the engines or fuel systems control unit. If the pump is electrically driven, it is important to have the right generator sizing in combination with the pump sizing for “direct drive” of the pump during braking to minimize loss and optimize total drive cycle consumption In the description that follows, the pump 114 is controllable by the controller 106.

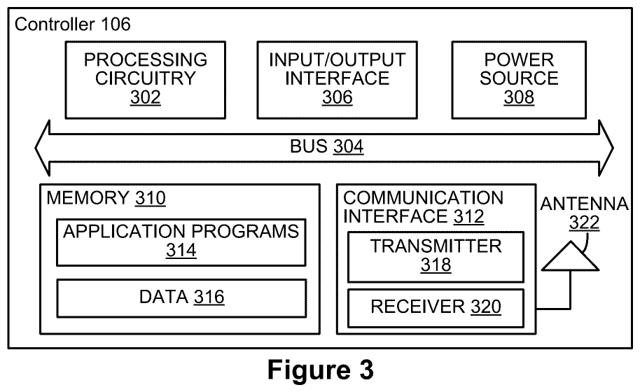

FIG. 3 illustrates an embodiment of a controller 106 for implementing embodiments described herein. Turning to FIG. 3, the controller 106 is adapted to execute instructions from a computer-readable medium to perform these and/or any of the functions or processing described herein. The controller 106 may be connected (e.g., networked) to other machines in a LAN, an intranet, an extranet when the vehicle 10 is stationary or the Internet when the vehicle 10 is in motion. The controller 106 may be integrated with a control system of the vehicle 10 in some embodiments. In other embodiments, the controller 106 may include any collection of devices that individually or jointly execute a set (or multiple sets) of instructions to perform any one or more of the methodologies discussed herein.

The controller 106 may comprise any computing or electronic device capable of including firmware, hardware, and/or executing software instructions to implement the functionality described herein. The controller 106 includes a processor device 302 (may also be referred to as a control unit or processing circuitry), a memory 304, and a system bus 306. The system bus 306 provides an interface for system components including, but not limited to, the memory 304 and the processor device 302. The processor device 302 may include any number of hardware components for conducting data or signal processing or for executing computer code stored in memory 304. The processor device 302 (i.e., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 306 may be any of several types of bus structures that may further interconnect to a memory bus (with or without a memory controller), a peripheral bus, and/or a local bus using any of a variety of bus architectures. The memory 304 may be one or more devices for storing data and/or computer code for completing or facilitating methods described herein. The memory 304 may include database components, object code components, script components, or other types of information structure for supporting the various activities herein. Any distributed or local memory device may be utilized with the systems and methods of this description. The memory 304 may be communicably connected to the processor device 302 (e.g., via a circuit or any other wired, wireless, or network connection) and may include computer code for executing one or more processes described herein. The memory 304 may include non-volatile memory 308 (e.g., read-only memory (ROM), erasable programmable read-only memory (EPROM), electrically erasable programmable read-only memory (EEPROM), etc.), and volatile memory 310 (e.g., random-access memory (RAM)), or any other medium which can be used to carry or store desired program code in the form of machine-executable instructions or data structures and which can be accessed by a computer or other machine with a processor device 302. A basic input/output system (BISO) 312 may be stored in the non-volatile memory 308 and can include the basic routines that help to transfer information between elements within the controller 106.

The controller 106 may further include or be coupled to a non-transitory computer-readable storage medium such as the storage device 314, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 314 and other drives associated with computer-readable media and computer-usable media may provide non-volatile storage of data, data structures, computer-executable instructions, and the like.

A number of modules can be stored in the storage device 314 and in the volatile memory 310, including an operating system 316 and one or more program modules 318, which may implement the functionality described herein in whole or in part. All or a portion of the examples disclosed herein may be implemented as a computer program product 320 stored on a transitory or non-transitory computer-usable or computer-readable storage medium (i.e., single medium or multiple media), such as the storage device 314, which includes complex programming instructions, such as complex computer-readable program code, to cause the processor device 302 to carry out the steps described herein. Thus, the computer-readable program code can comprise software instructions for implementing the functionality of the examples described herein when executed by the processor device 302. The processor device 302 may serve as a controller, or control system, for the controller 106 that is to implement the functionality described herein.

The controller 106 also may include an input device interface 322 (e.g., input device interface and/or output device interface). The input device interface 322 may be configured to receive input and selections to be communicated to the controller 106 when executing instructions, such as from a keyboard, mouse, touch-sensitive surface, etc. Such input devices may be connected to the processor device 302 through the input device interface 322 coupled to the system bus 306 but can be connected through other interfaces such as a parallel port, an Institute of Electrical and Electronic Engineers (IEEE) 1394 serial port, a Universal Serial Bus (USB) port, an IR interface, and the like. The controller 106 may include an output device interface 324 configured to forward output, such as to a display, a video display unit (e.g., a liquid crystal display (LCD) or a cathode ray tube (CRT)). The controller 106 may also include a communications interface 326 suitable for communicating with a network as appropriate or desired.

Returning to FIG. 2, a hydrogen pump 112 and a pump valve 114 are connected between the fuel tank valves 1081-108N and the fuel tank valve 110 and are controlled by controller 106. A first valve 116, controlled by controller 106, is connected to fuel tank valves 1081-108N. A second valve 118, also controlled by controller 106, is connected to the fuel tank valve 110.

The first valve 116 and the second valve 118 are connected to the fuel consumer 120 via pressure regulator 122 and manifold 124. The first valve 116 is connected to the fuel tank valves 1081-108N via manifold 126. Manifold 124 and manifold 126 are pipes in some aspects and used to connect the fuel tank valves 1081-108N and 110 to the hydrogen fuel system 100.

In the various scenarios described below, the controller 106 uses one or several of the hydrogen tanks at a time depending on the embodiment. During braking, the hydrogen in the partially spent hydrogen fuel tanks is re-distributed, pumped, to another of the partially spent hydrogen fuel tanks (i.e., creating a substantially full tank, primarily the “booster tank” (i.e., the at least one hydrogen fuel tank 104) as described herein.

There are thresholds used in the various scenarios. These thresholds are defined by the fuel consumer (e.g., the truck 10) system's lower operating pressure requirements, which depend on engine system, power levels, etc. These thresholds may include the following thresholds:
Full tank (i.e., substantially full or close to full tank)·
Upper threshold between the full tank and the intermediate threshold, in a range of around 70% to around 95%, for example 630 bar/90%
Intermediate threshold between the upper threshold and the lower threshold, in a range of near the lower threshold and the upper threshold such as a threshold in the range of around 20% to around 80%, for example 70%
Lower threshold between the intermediate threshold and the empty tank threshold, in a range of near the empty tank and below the intermediate threshold such as a threshold in the range of around 10% to around 50%, for example 200 bar/28%
Empty tank (i.e., substantially empty or close to empty tank)

While five thresholds are illustrated, there may be additional thresholds or fewer thresholds. The ranges described above are examples and other ranges and thresholds may be used.

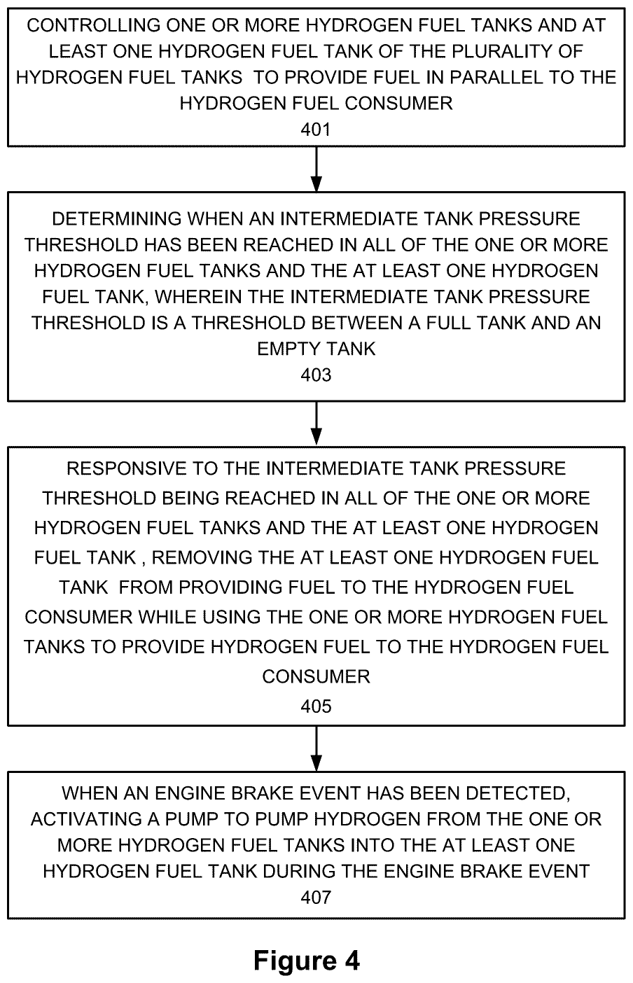

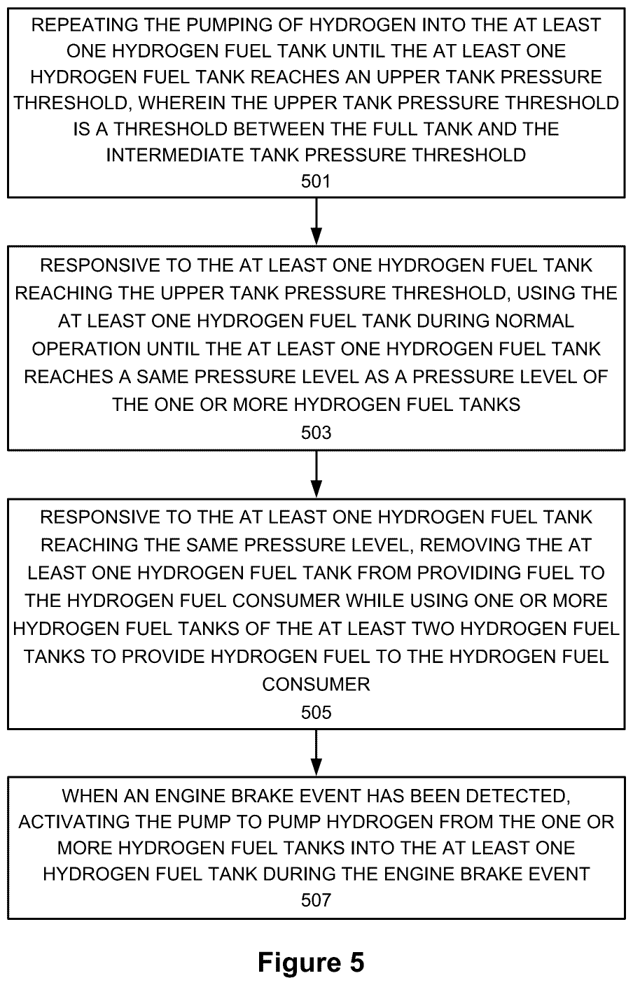

FIGS. 4-5 illustrate operations the controller 106 performs in a first scenario to increase efficiency in a hydrogen fuel system (100) requiring high pressure hydrogen injection and configured to provide brake energy recovery, the hydrogen fuel system (100) having a plurality of hydrogen fuel tanks (1021-102N, 104) where in some embodiments, all hydrogen fuel tanks 1021-102N and the at least one hydrogen fuel tank 104 are used until a pre-determined threshold (e.g., the intermediate threshold) is reached.

In the description that follows, when a valve (e.g., fuel tank valve, first valve, second valve, etc.) is open, the input and output of the valve are fluidly connected, and hydrogen fuel can flow through the valve. When a valve is closed, the input and output of the valve are not fluidly connected, and no hydrogen fuel flows through the valve.

Turning to FIG. 4, in block 401, the controller 106 controls at least two hydrogen fuel tanks of the plurality of hydrogen fuel tanks (1021-102N, 104) to provide fuel in parallel to the hydrogen fuel consumer. For example, in FIG. 2, the controller 106 controls the first valve 116, the second valve 118, and the fuel tank valves 1081 to 108N, 110 of one or more hydrogen fuel tanks of the other hydrogen fuel tanks 1021-102N and the at least one hydrogen fuel tank 104 to provide fuel in parallel to the hydrogen fuel consumer 120 by opening the first valve 116, the second valve 118, the fuel tank valve 110 of the at least one hydrogen fuel tank 104, and one or more fuel tank valves of the fuel tank valves 1081-108N of the other hydrogen fuel tanks 1021-102N so that hydrogen fuel flows from the at least one hydrogen fuel tank 104 and one or more fuel tank valves of the fuel tank valves 1081-108N.

In an embodiment where all hydrogen fuel tanks are used, hydrogen fuel tanks 1021-102N and the at least one hydrogen fuel tank 104 are used in parallel by opening all of the fuel tank valves 1081-108N, 110.

The controller 106 provides fuel in parallel to the hydrogen fuel consumer until all hydrogen fuel tanks providing hydrogen fuel to the fuel consumer 120 have reached an intermediate tank pressure threshold. In some embodiments, no brake energy recovery with the hydrogen pump 112 will be performed before this intermediate tank pressure threshold is reached.

In block 403, the controller 106 determines when the intermediate tank pressure threshold has been reached in the one or more hydrogen fuel tanks of the other hydrogen fuel tanks 1021-102N and the at least one hydrogen fuel tank 104, wherein the intermediate tank pressure threshold is a threshold between a full tank and an empty tank. For example, in the embodiment where all hydrogen fuel tanks are used, the controller 106 determines when the intermediate tank pressure threshold has been reached in all of the hydrogen fuel tanks 1021-102N and the at least one hydrogen fuel tank 104.

In block 405, the controller 106, responsive to the intermediate tank pressure threshold being reached in all of the at least two hydrogen fuel tanks, removes the at least one hydrogen fuel tank 104 of the at least two hydrogen fuel tanks from providing fuel to the hydrogen fuel consumer by closing the second valve 118 while using the one or more hydrogen fuel tanks 1021-102N of the at least two hydrogen fuel tanks to provide hydrogen fuel to the hydrogen fuel consumer 120.

In block 407, the controller 106, when an engine brake event has been detected, activates a pump 112 to pump hydrogen from the one or more hydrogen fuel tanks 1021-102N into the at least one hydrogen fuel tank 104 during the engine brake event. In FIG. 2, the controller 106 opens the pump valve 114, closes the first valve 116 (and the second valve 118 if it was opened after block 405), and activates the pump 112 to pump hydrogen from the one or more hydrogen fuel tanks 1021-102N of the other hydrogen fuel tanks 1021-102N into the at least one hydrogen fuel tank 104 during the engine brake event.

FIG. 5 illustrates further operations the controller 106 performs. Turning to FIG. 5, in block 501, the controller 106 repeats the pumping of hydrogen into the at least one hydrogen fuel tank 104 until the at least one hydrogen fuel tank 104 reaches an upper tank pressure threshold, wherein the upper tank pressure threshold is a threshold between the full tank and the intermediate tank pressure threshold. In the embodiment illustrated in FIG. 2, the controller 106 repeats the pumping by repeating the opening of the pump valve 114, closing of the first valve 116 and activating of the pump 112 to pump hydrogen from the one or more hydrogen fuel tanks 1021-102x of the other hydrogen fuel tanks 1021-102x into the at least one hydrogen fuel tank 104 during the engine brake event until the at least one hydrogen fuel tank 104 reaches an upper tank pressure threshold.

In block 503, the controller 106 responsive to the at least one hydrogen fuel tank 104 reaching the upper tank pressure threshold, uses the at least one hydrogen fuel tank 104 during normal operation until the at least one hydrogen fuel tank 104 reaches a same pressure level as a pressure level of the one or more hydrogen fuel tanks 1021-102N. In the embodiment illustrated in FIG. 2, the controller 106 uses the at least one hydrogen fuel tank 104 during normal operation by opening the second valve 118 and closing the pump valve 114 until the at least one hydrogen fuel tank 104 reaches a same pressure level as a pressure level of the one or more hydrogen fuel tanks 1021-102N. In some embodiments where only the at least one hydrogen fuel tank 104 is providing hydrogen fuel to the hydrogen fuel consumer 120, at least the first valve 116 is closed. Fuel tank valves 1081-108 may also be closed.

In block 505, the controller 106, responsive to the at least one hydrogen fuel tank 104 reaching the same pressure level, removes the at least one hydrogen fuel tank 104 from providing hydrogen fuel to the hydrogen fuel consumer while using one or more hydrogen fuel tanks 1021-102x of the at least two hydrogen fuel tanks to provide hydrogen fuel to the hydrogen fuel consumer. In the embodiment illustrated in FIG. 2, the controller 106 removes the at least one hydrogen fuel tank 104 from providing hydrogen fuel to the hydrogen fuel consumer 120 by closing the second valve 118 while using the one or more hydrogen fuel tanks 1021-102x to provide hydrogen fuel to the hydrogen fuel consumer by opening the first valve 116 if the first valve 116 is closed. Furthermore, the one or more fuel tank valves 1081-108x of the one or more hydrogen fuel tanks 1021-102x being used to provide hydrogen fuel to the hydrogen fuel consumer 120 are opened if they are closed to provide the hydrogen fuel.

In block 507, the controller 106, when an engine brake event has been detected, activates the pump 112 to pump hydrogen from the one or more hydrogen fuel tanks 1021-102N into the at least one hydrogen fuel tank 104 during the engine brake event. In the embodiment illustrated in FIG. 2, the controller 106 closes the first valve 116, opens the pump valve 114, and activates the pump 112. The fuel tank valve 110 is opened if it was closed and the second valve 116 is closed if it was open.

The controller performs the above operations of FIGS. 4 and 5 until all hydrogen fuel tanks 1021-102N are substantially empty except for the at least one hydrogen fuel tank 104, which will have a remaining pressure level of the lower threshold.

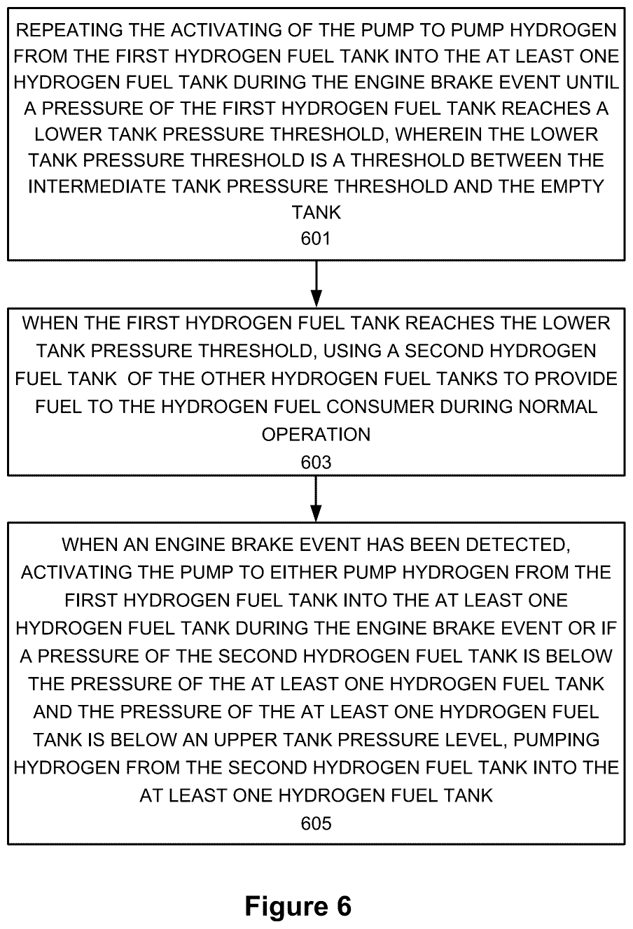

FIGS. 6-10 are flowcharts illustrating embodiments of a second scenario, similar to the first scenario. In the second scenario, two tanks are used in parallel until a pre-set tank threshold (e.g., the intermediate threshold) is reached. The brake energy recovery will not start until the two tanks have reached this threshold.

In FIGS. 6-10, the at least two hydrogen fuel tanks of the plurality of hydrogen fuel tanks comprises a first hydrogen fuel tank (1021) of the other hydrogen fuel tanks (1021-102N) and the at least one hydrogen fuel tank (104) and other hydrogen fuel tanks (1022-102N) of the plurality of hydrogen tanks are not initially used. The corresponding fuel tank valve (1022-102N) of the other hydrogen fuel tanks (1022-102x) are closed.

Turning to FIG. 6, in block 601, the controller 106 repeats the activating of the pump 112 to pump hydrogen from the first hydrogen fuel tank 1021 into the at least one hydrogen fuel tank 104 during the engine brake event until a pressure of the first hydrogen fuel tank 1021 reaches a lower tank pressure threshold. In the embodiment illustrated in FIG. 2, the controller 106 repeats the closing of the first valve 116, opening of the pump valve 114, and activating of the pump 112 to pump hydrogen from the first hydrogen fuel tank 1021 into the at least one hydrogen fuel tank 104 during the engine brake event until a pressure of the first hydrogen fuel tank 1021 reaches a lower pressure tank threshold.

In block 603, the controller 106, when the first hydrogen fuel tank 1021 reaches the lower tank pressure threshold, uses a second hydrogen fuel tank 1022 of the other hydrogen fuel tanks 1022-102N to provide fuel to the hydrogen fuel consumer 120 during normal operation. In the embodiment illustrated in FIG. 2, the controller 106 uses the second hydrogen fuel tank 1022 by opening the fuel tank valve 1082 associated with the second hydrogen fuel tank 1022.

In block 605, the controller 106, when an engine brake event has been detected, activates the pump 112 to either pump hydrogen from the first hydrogen fuel tank 1021 into the at least one hydrogen fuel tank 104 during the engine brake event or if a pressure of the second hydrogen fuel tank 1022 is below the pressure of the at least one hydrogen fuel tank 104 and the pressure of the at least one hydrogen fuel tank 104 is below an upper tank pressure level, pumps hydrogen from the second hydrogen fuel tank 1022 into the at least one hydrogen fuel tank 104. In the embodiment illustrated in FIG. 2, when an engine brake event has been detected, the controller 106 closes the first valve 116, opens the pump valve 114 and activates the pump 112 to either pump hydrogen from the first hydrogen fuel tank 1021 into the at least one hydrogen fuel tank 104 by opening the fuel tank valve 1081 associated with the first hydrogen fuel tank 1021 during the engine brake event or if a pressure of the second hydrogen fuel tank 1022 is below the pressure of the at least one hydrogen fuel tank 104 and the pressure of the at least one hydrogen fuel tank 104 is below an upper tank pressure level, pumping hydrogen from the second hydrogen fuel tank 1022 into the at least one hydrogen fuel tank 104 by opening the fuel tank valve 1082 associated with the second hydrogen fuel tank 1022 and if open, closes the fuel tank valve 1081 associated with the first hydrogen fuel tank 1021.

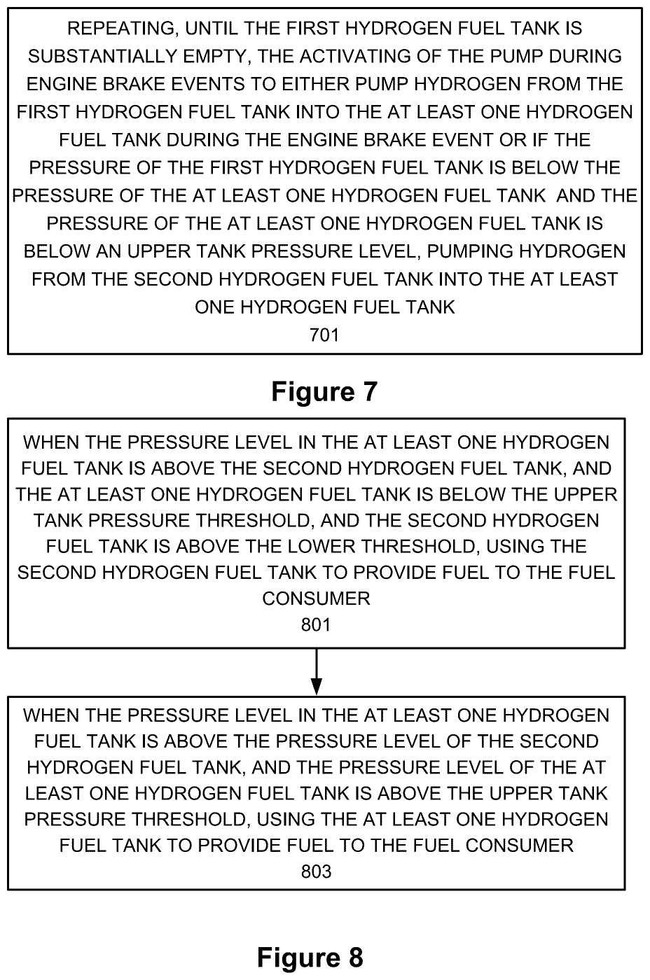

As illustrated in block 701 of FIG. 7, the controller 106 repeats, until the first hydrogen fuel tank 1021 is substantially empty, the activating of the pump 112 during engine brake events to either pump hydrogen from the first hydrogen fuel tank 1021 into the at least one hydrogen fuel tank 104 during the engine brake event or if the pressure of the second hydrogen fuel tank 1022 is below the pressure of the at least one hydrogen fuel tank 104 and the pressure of the at least one hydrogen fuel tank 104 is below an upper tank pressure level, pumping hydrogen from the second hydrogen fuel tank 1022 into the at least one hydrogen fuel tank 104. In the embodiment illustrated in FIG. 2, the controller 106 repeats, until the first hydrogen fuel tank 1021 is substantially empty, the closing of the first valve 116, the opening of the pump valve 114 and the activating of the pump 112 to either pump hydrogen from the first hydrogen fuel tank 1021 into the at least one hydrogen fuel tank by closing of the fuel tank valve 1081 associated with the first hydrogen fuel tank 1021 during the engine brake event or if a pressure of the second hydrogen fuel tank 1022 is below the pressure of the at least one hydrogen fuel tank 104 and the pressure of the at least one hydrogen fuel tank 104 is below an upper tank pressure level, pumping hydrogen from the second hydrogen fuel tank 1022 into the at least one hydrogen fuel tank 104 by opening of the fuel tank valve 1082 associated with the second hydrogen fuel tank 1022 and if open, closing of the fuel tank valve 1081 associated with the first hydrogen fuel tank 1021.

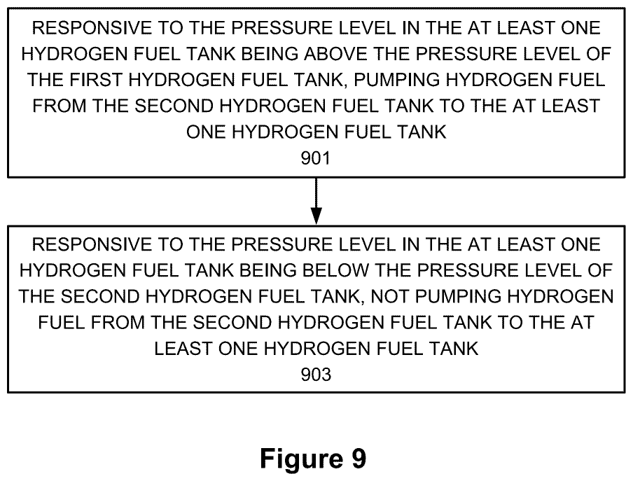

FIG. 8 illustrates operations the controller 106 performs when the first hydrogen fuel tank 1021 is substantially empty and normal operation is occurring. Turning to FIG. 8, in block 801, the controller 106, when the pressure level in the at least one hydrogen fuel tank 104 is above the second hydrogen fuel tank 1022, and the at least one hydrogen fuel tank 104 is below the upper tank pressure threshold; and the second hydrogen fuel tank 1022 is above the lower threshold, uses the second hydrogen fuel tank 1022 to provide fuel to the fuel consumer during operation of the hydrogen fuel consumer. In the embodiment illustrated in FIG. 2, the controller uses the second hydrogen fuel tank 1022 to provide fuel to the fuel consumer 120 by opening the first valve 116 and closing the second valve 118 and the fuel tank valve 110 of the at least one hydrogen fuel tank 104.

In block 803, the controller 106, when the pressure level in the at least one hydrogen fuel tank 104 is above the pressure level of the second hydrogen fuel tank 1022, and the pressure level of the at least one hydrogen fuel tank 104 is above the upper tank pressure threshold, uses the at least one hydrogen fuel tank 104 to provide fuel to the fuel consumer 120 by closing the first valve 116 and opening the second valve 118 and the fuel tank valve 110 of the at least one hydrogen fuel tank 104.

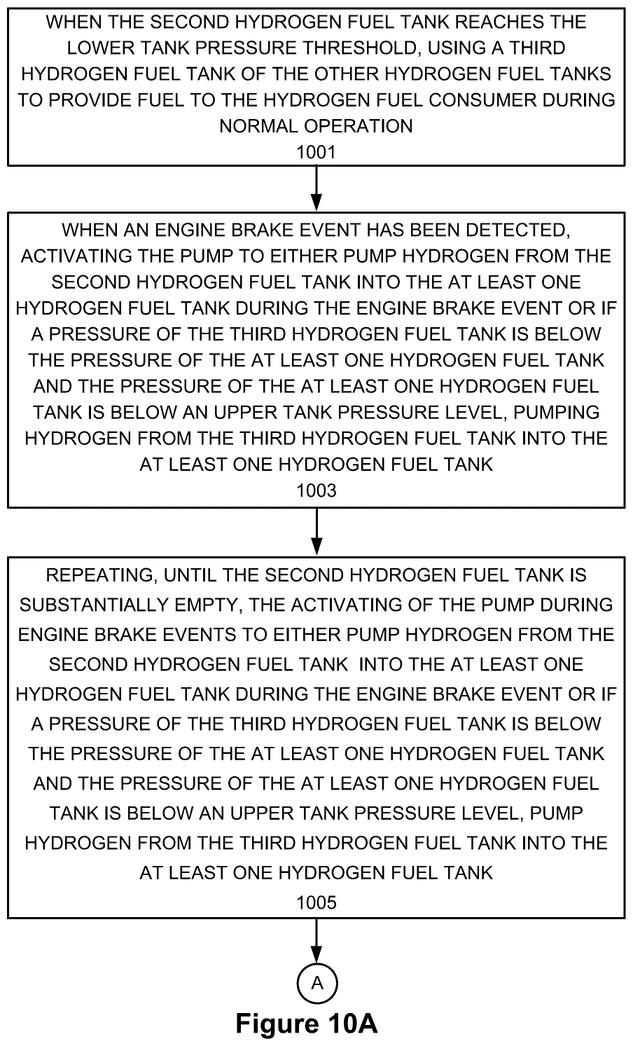

FIG. 9 illustrates operations the controller 106 performs when the first hydrogen fuel tank 1021 is substantially empty and a brake event has been detected. Turning to FIG. 9, in block 901, the controller 106, responsive to the pressure level in the at least one hydrogen fuel tank 104 being above the pressure level of the second hydrogen fuel tank 1022, pumps hydrogen fuel from the second hydrogen fuel tank 1022 to the at least one hydrogen fuel tank 104. In FIG. 2, the controller 106 pumps hydrogen fuel from the second hydrogen fuel tank 1022 to the at least one hydrogen fuel tank 104 by opening the pump valve 114 and activating the pump 112. If open, the controller 106 closes the first valve 116 and the second valve 118.

In block 903, the controller 106, responsive to the pressure level in the at least one hydrogen fuel tank 104 being below the pressure level of the second hydrogen fuel tank 1022, does not pump hydrogen fuel from the second hydrogen fuel tank 1022 to the at least one hydrogen fuel tank 104.

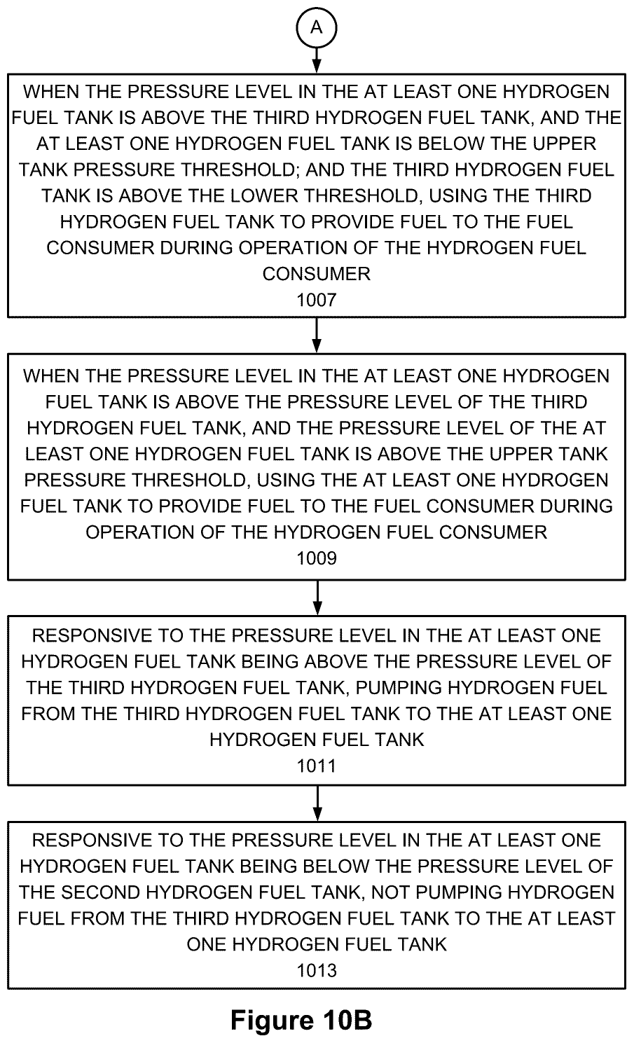

FIGS. 10A and 10B illustrate operations the controller 106 performs until all hydrogen fuel tanks (1022-102x) of the other hydrogen fuel tanks are substantially empty, leaving only the at least one hydrogen fuel tank (104) having hydrogen.

Turning to FIG. 10A, in block 1001, the controller 106, when the second hydrogen fuel tank 1022 reaches the lower tank pressure threshold, uses a third hydrogen fuel tank 1023 of the other hydrogen fuel tanks 1022-102x to provide fuel to the hydrogen fuel consumer during normal operation by opening fuel tank valve 1083. In the embodiment illustrated in FIG. 2, the controller 106 use the third hydrogen fuel tank 1023 of the other hydrogen fuel tanks 1022-102N to provide fuel to the hydrogen fuel consumer during normal operation by opening fuel tank valve 1083. In general, the controller 106, when the N−1th hydrogen fuel tank 102N-1 reaches the lower tank pressure threshold, uses the Nth hydrogen fuel tank 102x to provide fuel to the hydrogen fuel consumer during normal operation by opening fuel tank valve 108N.

In block 1003, the controller 106, when an engine brake event has been detected, activates the pump 112 to either pump hydrogen from the second hydrogen fuel tank 1022 into the at least one hydrogen fuel tank 104 during the engine brake event or if a pressure of the third hydrogen fuel tank 1023 is below the pressure of the at least one hydrogen fuel tank 104 and the pressure of the at least one hydrogen fuel tank 104 is below an upper tank pressure level, pumps hydrogen from the third hydrogen fuel tank 1023 into the at least one hydrogen fuel tank 104.

In the embodiment illustrated in FIG. 2, the controller 106, when an engine brake event has been detected, closes the first valve 116 and opens the pump valve 114 and activates the pump 112 to either pump hydrogen from the second hydrogen fuel tank 1022 into the at least one hydrogen fuel tank 104 during the engine brake event by opening the fuel tank valve 1082 or if a pressure of the third hydrogen fuel tank 1023 is below the pressure of the at least one hydrogen fuel tank 104 and the pressure of the at least one hydrogen fuel tank 104 is below an upper tank pressure level, pump hydrogen from the third hydrogen fuel tank 1023 into the at least one hydrogen fuel tank 104 by opening the fuel tank valve 1083.

In general, the controller 106 when an engine brake event has been detected, closes the first valve 116 and opens the pump valve 114 and activates the pump 112 to either pump hydrogen from the N−1th hydrogen fuel tank 102N-1 into the at least one hydrogen fuel tank 104 during the engine brake event by opening the fuel tank valve 108N-1 (and closing fuel tank valve 108N) or if a pressure of the Nth hydrogen fuel tank 102N is below the pressure of the at least one hydrogen fuel tank 104 and the pressure of the at least one hydrogen fuel tank 104 is below an upper tank pressure level, pump hydrogen from the Nth hydrogen fuel tank 102N into the at least one hydrogen fuel tank 104 by opening the fuel tank valve 108N and closing fuel tank valve 108N-1.

When the second hydrogen fuel tank (1022) is substantially empty and normal operation is occurring, the controller 106 performs operations of one of blocks 1007 or 1009:

Turning to FIG. 10B, in block 1007, when the pressure level in the at least one hydrogen fuel tank 104 is above the third hydrogen fuel tank 1023, and the at least one hydrogen fuel tank 104 is below the upper tank pressure threshold, and the third hydrogen fuel tank 1023 is above the lower threshold, the controller 106 uses the third hydrogen fuel tank 1023 to provide fuel to the fuel consumer 120 during operation of the hydrogen fuel system 100. In the embodiment illustrated in FIG. 2, the controller 106 pumps hydrogen from the third hydrogen fuel tank 1023 into the at least one hydrogen fuel tank 104 by opening the fuel tank valve 1083 and closing the fuel tank valve 1082.

Generally, when the N−1th hydrogen fuel tank is substantially empty and normal operation is occurring, in block 1007, when the pressure level in the at least one hydrogen fuel tank 104 is above the Nth hydrogen fuel tank 102N, and the at least one hydrogen fuel tank 104 is below the upper tank pressure threshold, and the Nth hydrogen fuel tank 102x is above the lower threshold, the controller 106 uses the Nth hydrogen fuel tank 102x to provide fuel to the fuel consumer 120 during operation of the hydrogen fuel system 100. In the embodiment illustrated in FIG. 2, the controller 106 pumps hydrogen from the Nth hydrogen fuel tank 102x into the at least one hydrogen fuel tank 104 by opening the fuel tank valve 108N and the first valve 116 and closing the second valve 118 and the pump valve 114 if open.

In block 1009, the controller 106, when the pressure level in the at least one hydrogen fuel tank 104 is above the pressure level of the third hydrogen fuel tank 1023 and the pressure level of the at least one hydrogen fuel tank 104 is above the upper tank pressure threshold, uses the at least one hydrogen fuel tank 104 to provide fuel to the fuel consumer 120 during normal operation of the hydrogen fuel system 100. In the embodiment illustrated in FIG. 2, the controller 106 uses the at least one hydrogen fuel tank 104 to provide fuel to the fuel consumer 120 by closing the first valve 116 and the fuel tank valve 1083 associated with the third hydrogen fuel tank 1023 and opening the second valve 118 and the fuel tank valve 110 associated with the at least one hydrogen fuel tank 104.

Generally, in block 1009, the controller 106, when the pressure level in the at least one hydrogen fuel tank 104 is above the pressure level of the Nth hydrogen fuel tank 102x and the pressure level of the at least one hydrogen fuel tank 104 is above the upper tank pressure threshold, uses the at least one hydrogen fuel tank 104 to provide fuel to the fuel consumer 120 during normal operation of the hydrogen fuel system 100 by closing the first valve 116 and the Nth fuel tank valve 108N associated with the Nth hydrogen fuel tank 102x and opening the second valve 118 and the fuel tank valve 110 associated with the at least one hydrogen fuel tank 104.

When another brake event has been detected after the second hydrogen fuel tank 1022 is substantially empty, the controller 106 performs one of blocks 1011 or 1013.

In block 1011, the controller 106, responsive to the pressure level in the at least one hydrogen fuel tank 104 is above the pressure level of the third hydrogen fuel tank 1023, pumps hydrogen fuel from the third hydrogen fuel tank 1023 to the at least one hydrogen fuel tank 104. In the embodiment illustrated in FIG. 2, pumps hydrogen fuel from the third hydrogen fuel tank 1023 to the at least one hydrogen fuel tank 104 by closing the first valve 116, opening the pump valve 114 and activating the pump 112. Thus, only fuel tank valve 1083, fuel tank valve 110 and pump valve 114 are open.

Generally, when another brake event has been detected after the N−1th hydrogen fuel tank 102N-1 is substantially empty, in block 1011, the controller 106, responsive to the pressure level in the at least one hydrogen fuel tank 104 is above the pressure level of the Nth hydrogen fuel tank 102N, pumps hydrogen fuel from the Nth hydrogen fuel tank 102N to the at least one hydrogen fuel tank 104 by closing the first valve 116, opening the pump valve 114 and activating the pump 112. Thus, only fuel tank valve 108N, fuel tank valve 110, and pump valve 114 are open.

In block 1013, the controller 106, responsive to the pressure level in the at least one hydrogen fuel tank 104 being below the pressure level of the third hydrogen fuel tank 1023, does not pump hydrogen fuel from the third hydrogen fuel tank 1023 to the at least one hydrogen fuel tank 104.

Generally, in block 1013, the controller 106, responsive to the pressure level in the at least one hydrogen fuel tank 104 being below the pressure level of the Nth hydrogen fuel tank 102N, does not pump hydrogen fuel from the Nth hydrogen fuel tank 102N to the at least one hydrogen fuel tank 104.

In the description above, FIG. 2 was used in the description of the functions of the valves and hydrogen fuel tanks. In FIG. 2, the pump 112 and pump valve 114 separate the plurality of hydrogen fuel tanks 1021 to 102N and fuel tank valves 1081 to 108N from the at least one hydrogen fuel tank 104 and fuel tank valve 110. In FIG. 2, the fuel tank valves 1081 to 108N and 110 can be two-way valves (i.e., on or off). The separation by the pump 112 and pump valve 114 means that the hydrogen fuel system 100 has to be shut down to have any of the plurality of hydrogen fuel tanks 1021 to 102N to be rerouted and used as the at least one hydrogen fuel tank 104.

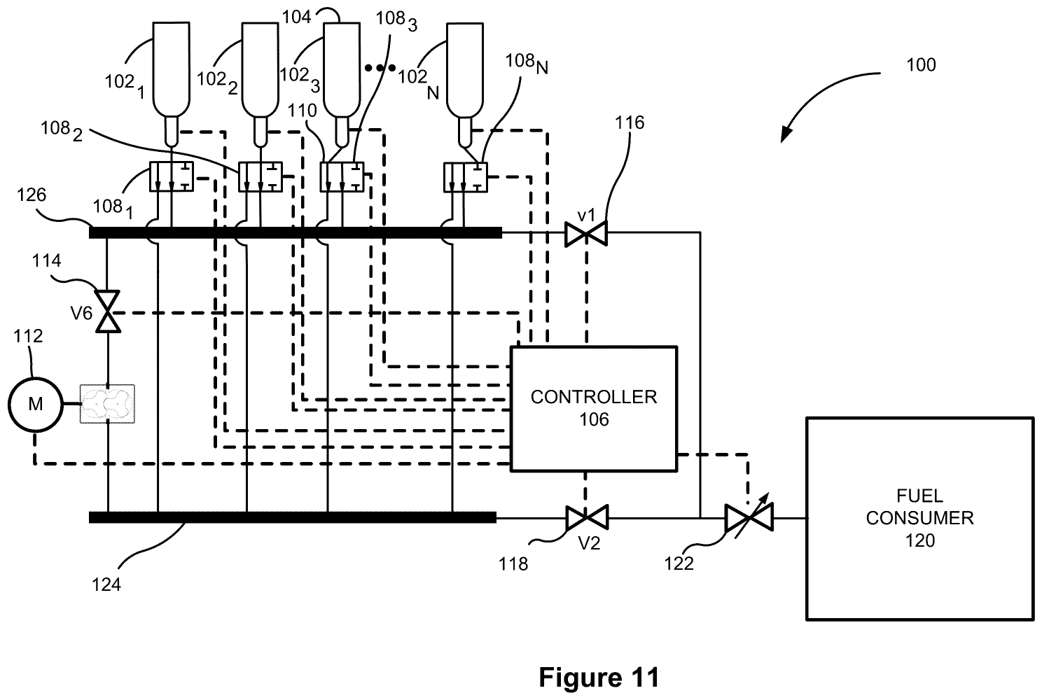

In another aspect as illustrated in FIG. 11, three-way valves are used as the fuel tank valves 1081 to 108N. A first port of the three-way valve is connected to manifold 124 and a second port of the three way valve is connected to manifold 126. A third port of the three-way valve is used to close the hydrogen fuel tank connected to the three-way valve so that the hydrogen fuel tank does not provide or receive hydrogen fuel in the hydrogen fuel system 100 . . . . The two manifolds 124, 126, which can be pipes, are used in a different manner than in FIG. 2. In particular, manifold 124 is used as a manifold for adding hydrogen fuel to the hydrogen fuel tank selected to be the at least one hydrogen fuel tank 104 and manifold 126 is used to provide fuel in parallel from the hydrogen fuel tanks not being used as the at least one hydrogen fuel tank 104.

During operation, the controller 106 determines which of the plurality of hydrogen fuel tanks 1021 to 102N is to be used as the at least one hydrogen fuel tank 104. The controller 106 controls the three-way valve associated with the hydrogen fuel tank selected to move to the first port and the remaining three-way valves to either be in the in the closed position of the third port or connected to the second port to supply hydrogen fuel via manifold 126. For example, as illustrated in FIG. 11, hydrogen fuel tank 1023 is selected to be the at least one hydrogen fuel tank. The controller 106 commands the three-way valve 1083 to move to the first port to connect the hydrogen fuel tank 1083 to manifold 124. The remaining hydrogen fuel tanks are either connected to manifold 126 or closed. In FIG. 11, hydrogen fuel tanks 1021 and 1022 are connected to manifold 126 while hydrogen fuel tank 108N is moved to the open position. The hydrogen fuel system is operated essentially the same way as described above where during braking, pump valve 114 is opened, the first valve 116 and the second valve 118 are closed and hydrogen fuel is pumped from the manifold 126 through the pump 112 and through the first port of the three-way valve 110 of the at least one hydrogen fuel tank 104 as described above.

With the above operations with the valve and hydrogen fuel tank arrangements describe in combination with pumping during brake events, the energy consumption (system efficiency) is minimized with no or little cost for fuel pressurization in the H2 vehicle system utilizing the hydrogen fuel system 100.

The system can be more optimized for different scenarios, especially with predictive control knowing the upcoming driving situation. A more flexible system, with many tanks (like usual for H2 storage systems) is therefore more optimal for predictive control of the system. Then the number of booster tanks and especially the threshold levels can be adjusted based on this knowledge.

Although the controller described herein may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

1. A method to increase efficiency in a hydrogen fuel system requiring high pressure hydrogen injection and configured to provide brake energy recovery, the hydrogen fuel system having a plurality of hydrogen fuel tanks, the method comprising:
controlling one or more hydrogen fuel tanks of the plurality of hydrogen fuel tanks and at least one hydrogen fuel tank to provide fuel in parallel to the hydrogen fuel consumer;
determining when an intermediate tank pressure threshold has been reached in all of the one or more hydrogen fuel tanks and the at the least one hydrogen fuel tank, wherein the intermediate tank pressure threshold is a threshold between a full tank and an empty tank; and
responsive to the intermediate tank pressure threshold being reached in all of the one or more hydrogen fuel tanks and the at the least one hydrogen fuel tank, removing the at least one hydrogen fuel tank from providing fuel to the hydrogen fuel consumer while using one or more hydrogen fuel tanks of the plurality of hydrogen fuel tanks to provide hydrogen fuel to the hydrogen fuel consumer;
when an engine brake event has been detected, activating a pump to pump hydrogen from at least one of the one or more hydrogen fuel tanks into the at least one hydrogen fuel tank during the engine brake event.

2. The method of claim 1, further comprising:
repeating the pumping of hydrogen into the at least one hydrogen fuel tank until the at least one hydrogen fuel tank reaches an upper tank pressure threshold, wherein the upper tank pressure threshold is a threshold between the full tank and the intermediate tank pressure threshold.

3. The method of claim 2, further comprising:
responsive to the at least one hydrogen fuel tank reaching the upper tank pressure threshold, using the at least one hydrogen fuel tank during normal operation until the at least one hydrogen fuel tank reaches a same pressure level as a pressure level of at least one of the one or more hydrogen fuel tanks.

4. The method of claim 3, further comprising:
responsive to the at least one hydrogen fuel tank reaching the same pressure level, removing the at least one hydrogen fuel tank from providing hydrogen fuel to the hydrogen fuel consumer while using one or more hydrogen fuel tanks of the at least two hydrogen fuel tanks to provide hydrogen fuel to the hydrogen fuel consumer; and
when an engine brake event has been detected, activating the pump to pump hydrogen from at least one of the one or more hydrogen fuel tanks into the at least one hydrogen fuel tank during the engine brake event.

5. The method of claim 1, wherein the at least two hydrogen fuel tanks of the plurality of hydrogen fuel tanks comprises the at least one hydrogen fuel tank and a first hydrogen fuel tank of the plurality of hydrogen fuel tanks and other hydrogen fuel tanks of the plurality of hydrogen tanks are not initially used, the method further comprising:
repeating the activating of the pump to pump hydrogen from the first hydrogen fuel tank into the at least one hydrogen fuel tank during the engine brake event until a pressure of the first hydrogen fuel tank reaches a lower tank pressure threshold level, wherein the low threshold level is less than the intermediate threshold;
when the first hydrogen fuel tank reaches the lower tank pressure threshold level, using a second hydrogen fuel tank of the other hydrogen fuel tanks to provide fuel to the hydrogen fuel consumer during normal operation; and
when an engine brake event has been detected, activating the pump to either pump hydrogen from the first hydrogen fuel tank into the at least one hydrogen fuel tank during the engine brake event or if a pressure of the second hydrogen fuel tank is below the pressure of the at least one hydrogen fuel tank and the pressure of the at least one hydrogen fuel tank is below an upper tank pressure threshold, pumping hydrogen from the second hydrogen fuel tank into the at least one hydrogen fuel tank, wherein the upper tank pressure threshold is between the full tank and the intermediate threshold.

6. The method of claim 5, further comprising:
repeating, until the first hydrogen fuel tank is substantially empty, the activating of the pump during engine brake events to either pump hydrogen from the first hydrogen fuel tank into the at least one hydrogen fuel tank during the engine brake event or if the pressure of the second hydrogen fuel tank is below the pressure of the at least one hydrogen fuel tank and the pressure of the at least one hydrogen fuel tank is below an upper tank pressure level, pumping hydrogen from the second hydrogen fuel tank into the at least one hydrogen fuel tank.

7. The method of claim 6, further comprising:
when the first hydrogen fuel tank is substantially empty and normal operation is occurring:
when the pressure level in the at least one hydrogen fuel tank is above the second hydrogen fuel tank, and the at least one hydrogen fuel tank is below the upper tank pressure threshold; and the second hydrogen fuel tank is above the lower threshold, using the second hydrogen fuel tank to provide fuel to the fuel consumer; and
when the pressure level in the at least one hydrogen fuel tank is above the pressure level of the second hydrogen fuel tank, and the pressure level of the at least one hydrogen fuel tank is above the upper tank pressure threshold, using the at least one hydrogen fuel tank to provide fuel to the fuel consumer.

8. The method of claim 7, further comprising:
when another brake event has been detected after the first hydrogen fuel tank is substantially empty:
responsive to the pressure level in the at least one hydrogen fuel tank being above the pressure level of the second hydrogen fuel tank, pumping hydrogen fuel from the second hydrogen fuel tank to the at least one hydrogen fuel tank; and
responsive to the pressure level in the at least one hydrogen fuel tank being below the pressure level of the second hydrogen fuel tank, not pumping hydrogen fuel from the second hydrogen fuel tank to the at least one hydrogen fuel tank.

9. The method of claim 5, further comprising performing the following operations until all hydrogen fuel tanks of the other hydrogen fuel tanks are empty, leaving only that at least one hydrogen fuel tank having hydrogen:
when the second hydrogen fuel tank reaches the lower tank pressure threshold, using a third hydrogen fuel tank of the other hydrogen fuel tanks to provide fuel to the hydrogen fuel consumer during normal operation;
when an engine brake event has been detected, activating the pump to either pump hydrogen from the second hydrogen fuel tank into the at least one hydrogen fuel tank during the engine brake event or if a pressure of the third hydrogen fuel tank is below the pressure of the at least one hydrogen fuel tank and the pressure of the at least one hydrogen fuel tank is below an upper tank pressure level, pumping hydrogen from the third hydrogen fuel tank into the at least one hydrogen fuel tank;
repeating, until the second hydrogen fuel tank is substantially empty, the activating of the pump during engine brake events to either pump hydrogen from the second hydrogen fuel tank into the at least one hydrogen fuel tank during the engine brake event or if a pressure of the third hydrogen fuel tank is below the pressure of the at least one hydrogen fuel tank and the pressure of the at least one hydrogen fuel tank is below an upper tank pressure level, pump hydrogen from the third hydrogen fuel tank into the at least one hydrogen fuel tank;
when the second hydrogen fuel tank is substantially empty and normal operation is occurring:
when the pressure level in the at least one hydrogen fuel tank is above the third hydrogen fuel tank, and the at least one hydrogen fuel tank is below the upper tank pressure threshold; and the third hydrogen fuel tank is above the lower threshold, using the third hydrogen fuel tank to provide fuel to the fuel consumer during operation of the hydrogen fuel system; and
when the pressure level in the at least one hydrogen fuel tank is above the pressure level of the third hydrogen fuel tank, and the at least one hydrogen fuel tank is above the upper tank pressure threshold, using the at least one hydrogen fuel tank to provide fuel to the fuel consumer during normal operation of the hydrogen fuel system
when another brake event has been detected after the second hydrogen fuel tank is substantially empty:
responsive to the pressure level in the at least one hydrogen fuel tank being above the pressure level of the third hydrogen fuel tank, pumping hydrogen fuel from the third hydrogen fuel tank to the at least one hydrogen fuel tank; and
responsive to the pressure level in the at least one hydrogen fuel tank being below the pressure level of the third hydrogen fuel tank, not pumping hydrogen fuel from the third hydrogen fuel tank to the at least one hydrogen fuel tank.

10. A hydrogen fuel system requiring high pressure hydrogen injection and configured to provide brake energy recovery, the hydrogen fuel system having a plurality of hydrogen fuel tanks, the hydrogen fuel system comprising:
a controller;
a plurality of hydrogen fuel tanks, each of the plurality of hydrogen fuel tanks controlled by a fuel tank valve, each fuel tank valve controlled by the controller;
a hydrogen pump controlled by the controller and configured to pump fuel to at least one hydrogen fuel tank of the plurality of hydrogen fuel tanks from other hydrogen fuel tanks of the plurality of fuel tanks;
a pump valve between the hydrogen pump and the other hydrogen fuel tanks;
a first valve between the fuel tank valves of the other hydrogen fuel tanks and a hydrogen fuel consumer; and
a second valve between the fuel tank valve of the at least one hydrogen fuel tank and the hydrogen fuel consumer;
wherein the controller is configured to:
control the first valve, the second valve, and the fuel tank valves of one or more hydrogen fuel tanks of the other hydrogen fuel tanks and the at least one hydrogen fuel tank to provide fuel in parallel to the hydrogen fuel consumer by opening the first valve, the second valve, the fuel tank valve of the at least one hydrogen fuel tank, and one or more fuel tank valves of the other hydrogen fuel tanks;
determine when an intermediate tank pressure threshold has been reached in the one or more hydrogen fuel tanks of the other hydrogen fuel tanks and the at least one hydrogen fuel tank, the intermediate tank pressure threshold being a threshold between a full tank and an empty tank;
responsive to the intermediate tank pressure threshold being reached in all of the one or more hydrogen fuel tanks of the other hydrogen fuel tanks and the at least one hydrogen fuel tank, remove the at least one hydrogen fuel tank from providing fuel to the hydrogen fuel consumer by closing the second valve while using at least one of the one or more hydrogen fuel tank of the other hydrogen fuel tanks to provide hydrogen fuel to the hydrogen fuel consumer;
when an engine brake event has been detected, open the pump valve, close the first valve and activate the pump to pump hydrogen from at least one of the one or more hydrogen fuel tanks of the other hydrogen fuel tanks into the at least one hydrogen fuel tank during the engine brake event.

11. The hydrogen fuel system of claim 10, further comprising a pressure regulator valve to regulate hydrogen fuel pressure of hydrogen fuel provided to the hydrogen fuel consumer.

12. The hydrogen fuel system of claim 10, wherein the controller is further configured to repeat the opening of the pump valve, closing of the first valve and activating of the pump to pump hydrogen from the one or more hydrogen fuel tanks of the other hydrogen fuel tanks into the at least one hydrogen fuel tank during the engine brake event until the at least one hydrogen fuel tank reaches an upper tank pressure threshold.

13. The hydrogen fuel system of claim 12, wherein the controller is further configured to:
responsive to the at least one hydrogen fuel tank reaching the upper tank pressure threshold, use the at least one hydrogen fuel tank during normal operation by opening the second valve and closing the pump valve until the at least one hydrogen fuel tank reaches a same pressure level as a pressure level of the one or more hydrogen fuel tanks.

14. The hydrogen fuel system of claim 13, wherein the controller is further configured to:
responsive to the at least one hydrogen fuel tank reaching the same pressure level, remove the at least one hydrogen fuel tank from providing hydrogen fuel to the hydrogen fuel consumer by closing the second valve while using the one or more hydrogen fuel tanks to provide hydrogen fuel to the hydrogen fuel consumer by opening the first valve if the first valve is closed; and
when an engine brake event has been detected, close the first valve, open the pump valve, and activate the pump to pump hydrogen from the remaining at least one hydrogen fuel tank into the at least one hydrogen fuel tank during the engine brake event.

15. The hydrogen fuel system of claim 10, wherein the at least two hydrogen fuel tanks of the plurality of hydrogen fuel tanks comprises a first hydrogen fuel tank of the other hydrogen fuel tanks and the at least one hydrogen fuel tank and other hydrogen fuel tanks of the plurality of hydrogen tanks are not initially used by closing the associated fuel tank valve of the other hydrogen fuel tanks, and wherein the controller is further configured to:
repeat the closing of the first valve, opening of the pump valve, and activating of the pump to pump hydrogen from the first hydrogen fuel tank into the at least one hydrogen fuel tank during the engine brake event until a pressure of the first hydrogen fuel tank reaches a low threshold level;
when the first hydrogen fuel tank reaches the lower tank pressure threshold, use a second hydrogen fuel tank of the other hydrogen fuel tanks to provide fuel to the hydrogen fuel consumer during normal operation by opening the fuel tank valve associated with the second hydrogen fuel tank; and
when an engine brake event has been detected, closing the first valve, opening the pump valve and activating the pump to either pump hydrogen from the first hydrogen fuel tank into the at least one hydrogen fuel tank by closing the fuel tank valve associated with the first hydrogen fuel tank during the engine brake event or if a pressure of the second hydrogen fuel tank is below the pressure of the at least one hydrogen fuel tank and the pressure of the at least one hydrogen fuel tank is below an upper tank pressure level, pumping hydrogen from the second hydrogen fuel tank into the at least one hydrogen fuel tank by opening the fuel tank valve associated with the second hydrogen fuel tank and if open, closing the fuel tank valve associated with the first hydrogen fuel tank.

16. The hydrogen fuel system of claim 15, wherein the controller is further configured to:
repeat, until the first hydrogen fuel tank is substantially empty, the closing of the first valve, the opening of the pump valve and the activating of the pump to either pump hydrogen from the first hydrogen fuel tank into the at least one hydrogen fuel tank by closing of the fuel tank valve associated with the first hydrogen fuel tank during the engine brake event or if a pressure of the second hydrogen fuel tank is below the pressure of the at least one hydrogen fuel tank and the pressure of the at least one hydrogen fuel tank is below an upper tank pressure level, pumping hydrogen from the second hydrogen fuel tank into the at least one hydrogen fuel tank by opening of the fuel tank valve associated with the second hydrogen fuel tank and if open, closing of the fuel tank valve associated with the first hydrogen fuel tank.

17. The hydrogen fuel system of claim 16, wherein the controller is further configured to:
when the first hydrogen fuel tank is substantially empty and normal operation is occurring:
when the pressure level in the at least one hydrogen fuel tank is above the second hydrogen fuel tank, and the at least one hydrogen fuel tank is below the upper tank pressure threshold; and the second hydrogen fuel tank is above the lower threshold, use the second hydrogen fuel tank to provide fuel to the fuel consumer by opening the first valve and closing the second valve and the fuel tank valve of the at least one hydrogen fuel tank; and
when the pressure level in the at least one hydrogen fuel tank is above the pressure level of the second hydrogen fuel tank, and the pressure level of the at least one hydrogen fuel tank is above the upper tank pressure threshold, use the at least one hydrogen fuel tank to provide fuel to the fuel consumer by closing the first valve and opening the second valve and the fuel tank valve of the at least one hydrogen fuel tank.

18. The hydrogen fuel system of claim 17, wherein the controller is further configured to:
when another brake event has been detected after the first hydrogen fuel tank is substantially empty:
responsive to the pressure level in the at least one hydrogen fuel tank being above the pressure level of the second hydrogen fuel tank, pump hydrogen fuel from the second hydrogen fuel tank to the at least one hydrogen fuel tank by opening the pump valve and activating the pump; and
responsive to the pressure level in the at least one hydrogen fuel tank is below the pressure level of the second hydrogen fuel tank, not pumping hydrogen fuel from the second hydrogen fuel tank to the at least one hydrogen fuel tank.

19. The hydrogen fuel system of claim 15, wherein the controller is further configured to perform the following operations until all hydrogen fuel tanks in the other hydrogen fuel tanks are substantially empty, leaving only the at least one hydrogen fuel tank having hydrogen:
when the second hydrogen fuel tank reaches the low threshold level, use a third hydrogen fuel tank of the other hydrogen fuel tanks to provide fuel to the hydrogen fuel consumer during normal operation by opening fuel tank valve;
when an engine brake event has been detected, close the first valve and open the pump valve and activate the pump to either pump hydrogen from the second hydrogen fuel tank into the at least one hydrogen fuel tank during the engine brake event by closing fuel tank valve or if a pressure of the third hydrogen fuel tank is below the pressure of the at least one hydrogen fuel tank and the pressure of the at least one hydrogen fuel tank is below an upper tank pressure level, pump hydrogen from the third hydrogen fuel tank into the at least one hydrogen fuel tank by opening the fuel tank valve and closing the fuel tank valve;
repeat, until the second hydrogen fuel tank is substantially empty, the opening of the pump valve, the closing of the first valve, and the activating of the pump during engine brake events to either pump hydrogen from the second hydrogen fuel tank into the at least one hydrogen fuel tank during the engine brake event or if a pressure of the third hydrogen fuel tank is below the pressure of the at least one hydrogen fuel tank and the pressure of the at least one hydrogen fuel tank is below an upper tank pressure level, pump hydrogen from the third hydrogen fuel tank into the at least one hydrogen fuel tank;
when the second hydrogen fuel tank is substantially empty and normal operation is occurring:
when the pressure level in the at least one hydrogen fuel tank is above the third hydrogen fuel tank, and the at least one hydrogen fuel tank is below the upper tank pressure threshold; and the third hydrogen fuel tank is above the lower threshold, use the third hydrogen fuel tank to provide fuel to the fuel consumer by opening the first valve and the fuel tank valve associated with the third hydrogen fuel tank and closing the second valve and the pump valve if open; and
when the pressure level in the at least one hydrogen fuel tank is above the pressure level of the third hydrogen fuel tank, and the at least one hydrogen fuel tank is above the upper tank pressure threshold, use the at least one hydrogen fuel tank to provide fuel to the fuel consumer by closing the first valve and the fuel tank valve associated with the third hydrogen fuel tank and opening the second valve and the fuel tank valve associated with the at least one hydrogen fuel tank;
when another brake event has been detected after the second hydrogen fuel tank is substantially empty:
responsive to the pressure level in the at least one hydrogen fuel tank being above the pressure level of the third hydrogen fuel tank, pump hydrogen fuel from the third hydrogen fuel tank to the at least one hydrogen fuel tank by closing the first valve, opening the pump valve and activating the pump; and
responsive to the pressure level in the at least one hydrogen fuel tank being below the pressure level of the third hydrogen fuel tank, not pumping hydrogen fuel from the third hydrogen fuel tank to the at least one hydrogen fuel tank.

20. (canceled)

21. A computer program product comprising a non-transitory storage medium including program code to be executed by processing circuitry of a controller, whereby execution of the program code causes the controller to perform operations comprising:
controlling one or more hydrogen fuel tanks of the plurality of hydrogen fuel tanks and at least one hydrogen fuel tank to provide fuel in parallel to the hydrogen fuel consumer;
determining when an intermediate tank pressure threshold has been reached in all of the one or more hydrogen fuel tanks and the at the least one hydrogen fuel tank, wherein the intermediate tank pressure threshold is a threshold between a full tank and an empty tank;
responsive to the intermediate tank pressure threshold being reached in all of the one or more hydrogen fuel tanks and the at the least one hydrogen fuel tank, removing the at least one hydrogen fuel tank from providing fuel to the hydrogen fuel consumer while using one or more hydrogen fuel tanks of the plurality of hydrogen fuel tanks to provide hydrogen fuel to the hydrogen fuel consumer;
when an engine brake event has been detected, activating a pump to pump hydrogen from at least one of the one or more hydrogen fuel tanks into the at least one hydrogen fuel tank during the engine brake event.
